(19) United States
(12) Patent Application Publication
(10) Pub. No.: US 2012/0016847 A1
(43) Pub. Date: Jan. 19, 2012

(54) File Management System And Method

(76) Inventors: Michael A Provencher, Cypress, TX (US); William R. Whipple, Mognolia, TX (US); Michael D. Pelham, Cypress, TX (US)

(21) Appl. No.: 13/260,345

(22) PCT Filed: Sep. 30, 2009
(86) PCT No.: PCT/US09/59143

§ 371 Date: Sep. 25, 2011

(51) Int. Cl. G06F 7/00; G06F 17/30

(52) U.S. Cl. 707/693; 707/705; 707/E17.01

(57) ABSTRACT

A file management system (22) and method intercept a request to access a main memory to run a file and redirect the request to a memory location other than the main memory.

### BACKGROUND

Computer files are sometimes compressed to conserve memory. Updating compressed files is difficult and hampers run-time performance.

### BRIEF DESCRIPTION OF THE DRAWINGS

FIG. 1 is a schematic illustration of a computing system and an associated file management system according to an example embodiment.

FIG. 2 is a flow diagram of a method of accessing a file using the file management system of FIG. 1 according to an example embodiment.

FIG. 3 is a schematic illustration of the computing system and the associated file management system of FIG. 1 upon installation of a file manager according to an example of embodiment.

FIG. 4 is a flow diagram of a method of installing the file manager of FIG. 3 and obtaining a compressed file according to an example embodiment.

FIG. 5 is a flow diagram of a method creating the interceptor and decompressing the compressed file according to an example embodiment.

### DETAILED DESCRIPTION OF THE EXAMPLE EMBODIMENTS

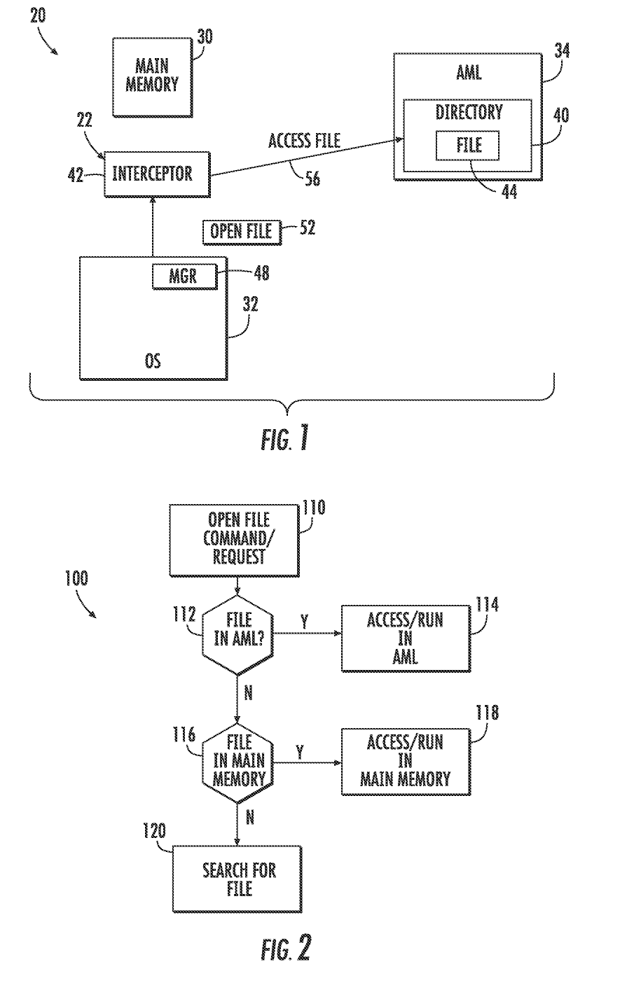

FIG. 1 schematically illustrates a computer system 20 and an associated file management system 22 according to an example embodiment. As will be described hereafter, file management system 22 facilitates compression of files while permitting updates to the files without substantial impairment of run-time performance.

Computer system 20 comprises a system of computer components configured to run or execute one more files which results in tangible changes external to the computing system. Such tangible changes may include the changing of an image, a display or other information presented on a display monitor or screen. Such tangible changes may include the output of control signals to an external device, causing the external device to perform one or more steps or operations. In other embodiments, other tangible changes may result from the operation of one of more of the files by the computer system 20.

Computer system 20 includes main memory 30, operating system 32 and alternative memory location 34. Main memory 30 comprises the main memory location at which operating system 32 stores files, programs and data. For purposes of this disclosure, a “main memory” shall mean a non-volatile memory location or structure in which a majority of files, programs and data accessed by a computing system are stored. In one embodiment, the main memory may store operating system 32. In one embodiment, main memory 30 may be a local non-volatile memory contained in the computing terminal such as the memory contained in the housing of the computing terminal or directly connected to the computing terminal via a universal serial bus port. For example, the main memory any contained in the housing a desktop computer or the housing of a laptop or notebook computer. In one embodiment, the main memory may comprise a hard disk drive, also referred to as a hard disk, hard drive or HDD. A hard disk drive comprises a non-volatile persistent memory storage device in which data stored on one or more rotating disks.

Operating system 32 comprises software or programming stored on the memory provided by main memory 30. Operating system 32 facilitates interface between a person and computing system 20. In one embodiment, operating system 32 is installed onto a main memory comprising a hard disk drive. In one embodiment, operating system 36 may comprise a disk operating system (DOS). One example of a DOS operating system is an operating system that runs on machines with INTEL X86 or compatible central processing units. One example of such an operating system is a WINDOWS based operating system such as WINDOWS XP, WINDOWS VISTA or WINDOWS 7 operating systems. Other examples of operating systems include, but are not limited to, LINUX, Mac OS X, Solaris, BSD and Amiga OS.

Alternative memory location 34 comprises a memory location other than the main memory 30. In one embodiment, alternative memory location 34 comprises a memory location other than a hard disk drive comprising main memory 30. Alternative memory location 34 may comprise volatile or non-volatile persistent memory. In one embodiment, alternative memory location has a memory storage capacity less than that of main memory 30. In one embodiment, alternative memory location 34 is remote from main memory 30 containing operating system 32 where communication is through a wired or wireless network (a local area network, a wide area network or internet) or is removably plugged into the computing terminal containing main memory 30 and operating system 32 via a universal serial bus (USB) port or similar plug. Examples of alternative memory location 34 include, but are not limited to, a random access memory which is local or provided in the same terminal or unit containing main memory 30, a portable external flash memory such as a jump drive which is connected to a computer terminal via a USB port or other connection or other wired or wireless interface, an external hard disk drive connected to the computing system by a USB port or other wired or wireless interface and memory contained in an external network server or a LINUX trapfs memory location.

File management system 22 comprises one or more executable computer files or computer readable programs or instructions configured to result in a compressed file being stored in an uncompressed state in the alternative memory location 34, to result in the interception of any requests for accessing the main memory 30 to run the file and to result in the intercepted request being redirected to the alternative memory location 34. The request may be to execute or run the file contained in alternative memory location 34 or to update the file or its data contained in the alternative memory location 34. Because the compressed file or payload, which may have been stored in the main memory 30 is uncompressed into the alternative memory location 34, the uncompressed file does not occupy memory space or resources of main memory 30. Because requests for accessing the uncompressed file are intercepted and redirected to the alternative memory location, the uncompressed file in alternative memory location 34 may be quickly accessed and run or updated without substantially impairing run-time performance.

File management system 22 includes directory 40 and interceptor 42. Directory 40 comprises a directory of files which correspond to or which is named or identified in a fashion similar to the directory for a file 44 had the file 44 been actually uncompressed and stored in main memory 30. File 44 may be an executable program, program settings, or data.

In one embodiment, directory 40 comprises an overlay file system into which the uncompressed file 44 is stored. An overlay file system is a pseudo file system that allows users to work with files from another file system without affecting it. The overlay file system provides a “mirror” of files in a mounted file system which users can access normally, except that all modifications to the mirror are stored on the side so that the original file system, referred to as the base file system, is unaffected. All modifications to user attributes, such as the owner and permissions, are saved by the overlay file system in its own storage. All modifications to the contents of files and directories are stored in another location, as specified when mounted.

In the example disclosed, because the uncompressed file is stored in an overlay file system, the file is in the mounted or base file system, while any subsequent changes are contained in the mirror or overlay storage.

Interceptor 42 comprises a computer program or computer readable instructions configured to intercept a request from operating system 32 to access main memory 30 and run or update a file 44 and to redirect the request to alternative memory location 34. In particular, interceptor 42 redirects or reroutes the request to directory 40 where the uncompressed file 44 is stored. According to one embodiment, interceptor 42 comprises a file system driver. According to one embodiment, interceptor 42 comprises a file system driver such as a unionfs or a bind mount of a tmpfs over relevant portions of a rootfs. In other embodiments, other file system drivers they employed as interceptor 42. Interceptor 42 may have other configurations as well.

As shown by FIG. 1, file management system 22 may include a file manager 48. File manager 48 comprises an executable computer program or file stored in a startup environment of the operating system 32. The executable file serving is that the file manager 48 is open upon startup of the operating system 32. In response to receiving a compressed file, file manager 48 creates directory 40 and uncompresses the compressed file to an uncompressed state (file 44) which is stored in directory 40. Manager 48 further creates or establishes interceptor 42. In one embodiment, interceptor 42 is stored in main memory 30 and is loaded into a random access memory. In other embodiments, correctly for you and interceptor 42 may be established in other fashions.

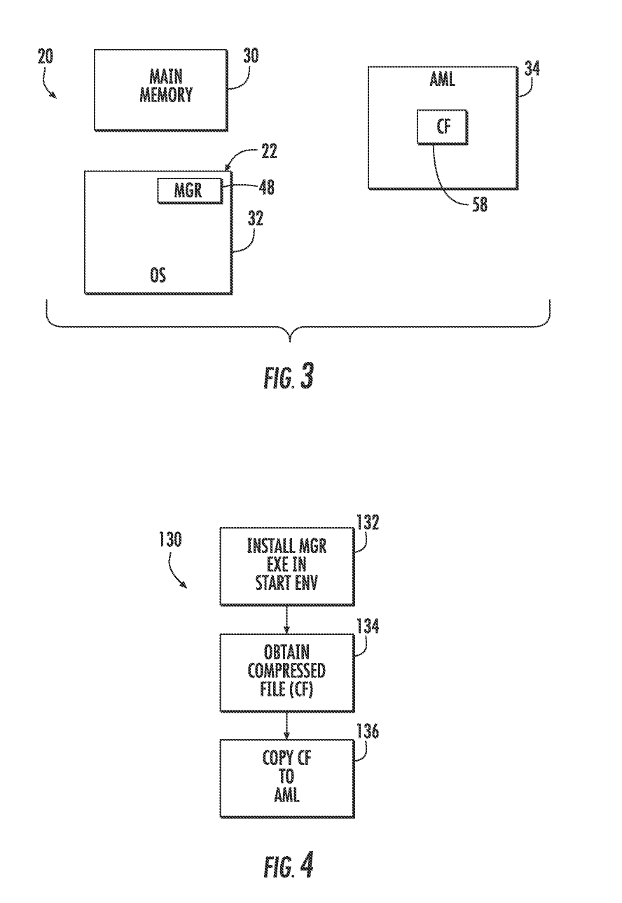

FIG. 2 is a flow diagram illustrating a method 100 of accessing files using file management system 22 according to an example embodiment. As indicated by step 110, an open file command 52 (schematically represented in FIG. 1) is received by operating system 32. This request 52 may be for the purpose of running the file or for updating the file. Request 52 may originate either directly from a person using computing system 20 or may originate from another file or program currently running which requires access to the file 44.

As indicated by step 112, interceptor 42 intercepts the open file command or request 52 prior to the command or request 52 being transmitted or forwarded to the file system driver which accesses main memory 30. As schematically indicated by arrow 56 in FIG. 1, interceptor 42 redirects the request 52 to directory 40. As indicated by step 114, if the uncompressed file 44 is contained in directory 40, file 44 is accessed while in directory 40 of alternative memory location 34. During such access, updated uncompressed file 44 may be run or updated. In other words, file 44 is run just as if file 44 alternatively been stored in an uncompressed state in main memory 30.

As indicated by step 116, if the file 44 is not contained in the alternative memory location 34 or directory 40, the open file request 52 is forwarded or transmitted to the file system driver which accesses main memory 30. At this point, the open file request 52 is handled as if interceptor 42 was not present. As indicated by step 118, if the uncompressed file is in main memory 30, the file in main memory 30 is accessed or run. In embodiments where the file is in a compressed state in main memory 30, the file is first uncompressed before such access or execution. As indicated by step 120, if the file is not in main memory 30, the operating system 32 may search for a compressed or uncompressed version of the file elsewhere. Alternatively, a file not found message may be presented to the user who made the request or to the file or program from which the request originated.

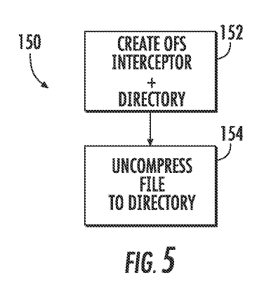

FIGS. 3-6 illustrate the establishment of file management system 22 in computing system 20 according to one example embodiment. FIG. 3 schematically illustrates computing system 20. FIG. 4 is a flow diagram of a method 130 establishing file management system 22 in the state shown in FIG. 3. As indicated by step 132, file manager 48 of file management system 22 is installed as an executable in a startup environment of operating system 32.

As indicated by step 134, a compressed file (CAPP) is Obtained. The CAPP may be obtained by a download from the Internet or a network source or may be obtained from a portable memory device storing the CAPP. As indicated by step 136, the CAPP is stored in the alternative memory location 34. In other embodiments, the CAPP may be stored in main memory 30 or another memory location.

FIG. 6 illustrates the further establishment of file management system 22 according to an example embodiment. FIG. 6 is a flow diagram of a method 150 establishing file management system 22 in the state shown in FIG. 1. As indicated by step 152, file manager 48 creates directory 40, an overlay file system for file 44, in alternative memory location 34. File manager 48 further creates interceptor 42. In one embodiment, interceptor 42 is stored in main memory 30 and loaded into a random access memory.

As indicated by step 154, file manager 48 uncompresses the compressed file (CAPP) 58 previously stored in the alternative media location 34 (shown in FIG. 3). The uncompressed file 44 is stored in directory 40 as shown in FIG. 1. At this point in time, the uncompressed file 44 is available for access in response to an open file or open file command or request 52 as discussed above with respect to FIGS. 1 and 2.

Overall, because the compressed file, which my have been stored in the main memory 30 is uncompressed into the alternative memory location 34, the uncompressed file does not occupy memory space or resources of main memory 30. Because requests for accessing the uncompressed file are intercepted and redirected to the alternative memory location, the uncompressed file in alternative memory location 34 may be quickly accessed and run or updated without substantially impairing run-time performance. In embodiments where the alternative memory location is a random access memory or other temporary storage location, such as a tmpfs LINUX, the tile is automatically removed upon shut down of the computer system without storage in main memory 30.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

1. An apparatus comprising:
a file management system comprising:
an interceptor program configured to intercept a request from an operating system to access a main memory and run or update a file and to redirect the request to a memory location other than the main memory storing the file.

2. The apparatus of claim 1 further comprising a file manager program configured to:
create an overlay file system in the memory location other than the main memory; and to create the interceptor program.

3. The apparatus of claim 2, wherein the file manager program is further configured uncompress the file and to store the file in the overlay file system.

4. The apparatus of claim 2 further comprising an operating system wherein the file manager program is stored in a startup environment of the operating system.

5. The apparatus of claim 1, wherein the interceptor program comprises a file system driver.

6. The apparatus of claim 5, wherein the file system driver is selected from a group of file system drivers consisting of: a unionfs or a bind mount of a tmpfs over relevant portions of a rootfs.

7. The apparatus of claim 1 further comprising:
a computer operating system;
the main memory; and
the memory location other than the main memory.

8. The apparatus of claim 7, wherein the memory location other than the main memory is selected from a group of memory location consisting of a random 3 access memory; an external hard disc drive; a portable external flash memory; a server or a LIMA tmpfs.

9. The apparatus of claim 7 further comprising a random access memory, wherein the interceptor program is stored in the main memory and loaded into the random access memory.

10. The apparatus of claim 1, wherein the main memory comprises a hard disk drive.

11. A file management method comprising:
intercepting a request in a computer to access a main memory run a file and redirecting the request to a memory location other than the main memory; and
executing the file from the memory location, wherein the executing of the file results in tangible changes external to the computer.

12. The method of claim 11, wherein the main memory comprises a hard disk drive.

13. The method of claim 11 further comprising creating an overlay file system the memory location, wherein the file is stored in the overlay file system.

14. The method of claim 11, wherein the memory location other than the main memory is selected from a group of memory location consisting of a random access memory; an external hard disk drive; a portable external flash memory; a server or a LINUX tmpfs.

15. The method of claim 11 further comprising creating an interceptor program wherein the interceptor program performs the intercepting of the request and the redirecting of the request.
